(19) United States
(12) Patent Application Publication
(10) Pub. No.: US 2008/0266429 A1
(43) Pub. Date: Oct. 30, 2008

(54) ADAPTIVE COMPENSATION FOR DEFECTIVE PIXELS

(75) Inventors: Frederic Jean Noraz, Gattieres (FR); Stephen Nicolas Busch, Le Cannet (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/770,015

(22) Filed: Jun. 28, 2007

(30) Foreign Application Priority Data
Apr. 30, 2007 (EP) 07290538.3

(51) Int. Cl. H04N 9/64; H04M 1/00

(52) U.S. Cl. 348/247; 455/556.1; 348/E09.001; 348/E09.037

(57) ABSTRACT

A system comprising a sensor having a photosensitive element that is adapted to capture images. The system also includes processing logic adapted to determine the probability that the photosensitive element is defective, based on digital values from multiple images. The digital values are associated with the photosensitive element. If the probability exceeds a threshold, the processing logic adjusts a digital value of another image captured using the photosensitive element.

### CROSS-REFERENCE TO RELATED APPLICATIONS

This application claims priority to EPO Patent Application No. 07290538.3, filed on Apr. 30, 2007, incorporated herein by reference.

### BACKGROUND

A digital imaging device, such as a digital camera, captures images using a sensor in the device. The sensor comprises an array of photosensitive elements (e.g., light-sensitive capacitors or transistors) which are often referred to as “pixels.” The quality of images captured using a digital imaging device is negatively affected by defective pixels (e.g., “dead” or “hot” pixels).

### SUMMARY

Accordingly, there are disclosed herein techniques by which image blemishes caused by defective pixels are removed from the images. An illustrative embodiment comprises a system comprising a sensor having a photosensitive element that is adapted to capture images. The system also includes processing logic adapted to determine the probability that the photosensitive element is defective, based on digital values from multiple images. The digital values are associated with the photosensitive element. If the probability exceeds a threshold, the processing logic adjusts a digital value of another image captured using the photosensitive element.

Another illustrative embodiment includes a system that includes processing logic and a sensor comprising a photosensitive pixel adapted to store a charge. The system also includes converter logic adapted to convert the charge to a digital value. The system further includes storage comprising a data structure, where the data structure cross-references the photosensitive pixel with a probability value that the photosensitive pixel is defective. For each of a plurality of images captured by the sensor, the processing logic uses a digital value associated with the photosensitive pixel to adjust the probability value. If the probability value exceeds a threshold, the processing logic adjusts a digital value of another image, where the another image is captured by the photosensitive pixel.

Yet another illustrative embodiment includes a method that comprises capturing multiple images using a photosensitive element, where the images are associated with multiple digital values. The method also comprises determining differences between the multiple digital values. Based on the differences, the method includes adjusting a probability value which indicates the probability that the photosensitive element is defective. If the probability exceeds a threshold, the method comprises adjusting a different digital value of a different image, where the different digital value is associated with the photosensitive element.

### BRIEF DESCRIPTION OF THE DRAWINGS

For a detailed description of exemplary embodiments of the invention, reference will now be made to the accompanying drawings in which:

FIG. 1 shows an illustrative system implementing techniques disclosed herein, in accordance with preferred embodiments of the invention;

FIG. 2a shows an illustrative block diagram of circuit logic included in the system of FIG. 1, in accordance with various embodiments of the invention;

FIG. 2b shows an illustrative pixel constellation associated with a sensor of the circuit logic of FIG. 2a, in accordance with embodiments of the invention;

FIG. 3 shows an illustrative data structure stored within storage of the circuit logic of FIG. 2a, in accordance with preferred embodiments of the invention; and

FIG. 4 shows an illustrative flow diagram of a method implemented in accordance with various embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “connection” refers to any path via which a signal may pass. For example, the term “connection” includes, without limitation, wires, traces and other types of electrical conductors, optical devices, etc. The term “photosensitive element” refers not only to a light-collecting element such as a pixel, but also includes hardware associated with a light-collecting element, such as wiring, amplifiers, etc. Any hardware logic whose defectiveness precludes the accurate capture of light is associated with the term “photosensitive element.”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Digital imaging devices (e.g., digital cameras, camera phones) that contain sensors with defective pixels produce blemished images. Described herein are various embodiments of a technique by which the image blemishes caused by such defective pixels are removed so that they are no longer visible to the naked eye. Removal of the blemishes requires the identification of the defective pixels which cause these blemishes. In order to accurately identify which pixels in a sensor are defective and which are not, the disclosed technique analyzes each captured image and determines, for each pixel of the sensor, the probability that that pixel is defective. This probability information is refined and made more accurate by repeating the process over time, using several images.

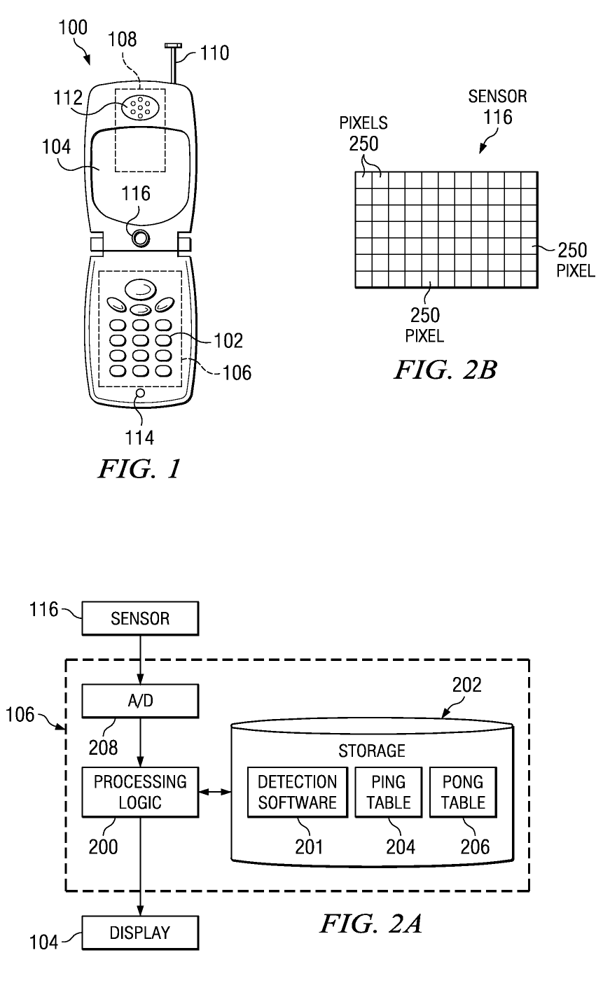

FIG. 1 shows an illustrative mobile communication device 100 (e.g., a cell phone) implementing at least some of these techniques. The device 100 comprises a battery-operated apparatus which includes an integrated keypad 102, display 104 and radio frequency (“RF”) circuitry 108. The display 104 may comprise any suitable display, such as a liquid crystal display (LCD). The device 100 also includes an electronics package 106 coupled to the keypad 102, display 104 and radio frequency (“RF”) circuitry 108. The electronics package 106 contains various electronic components used by the device 100, including processing logic, storage logic, one or more batteries, etc. The device 100 also comprises a speaker 112, used to output audible signals, and a microphone 114, used to receive audible signals.

The device 100 further includes an imaging device or sensor (e.g., a camera) 116 which may be used to capture digital images (i.e., photographs) and/or video. The sensor 116 couples to a lens (also represented as numeral 116) and is considered to be part of a camera module housed within the device 100 (not specifically shown). The RF circuitry 108 may couple to an antenna 110 by which data transmissions are sent and received. Although the mobile communication device 100 is represented as a mobile phone in FIG. 1, the scope of this disclosure is not limited to mobile phones and also may include personal digital assistants (e.g., BLACKBERRY® or PALM® devices), multi-purpose audio devices (e.g., APPLE® iPHONE® devices), portable computers or any other suitable electronic device(s). In other embodiments, the device is not battery-operated and/or not portable. In some embodiments, the device 100 is a digital camera or a smart camera (e.g., used in video surveillance) instead of a mobile communication device. The contents of the electronics package 106, which implement techniques in accordance with embodiments of the invention, are now described in detail with reference to FIG. 2a.

FIG. 2a shows circuit logic housed within, or coupled to, the electronics package 106 of FIG. 1. Specifically, FIG. 2a shows the electronics package 106 comprising a processing logic 200 (e.g., an image processor) coupled to a storage 202 comprising multiple data structures 204 and 206. For reasons explained below, the data structure 204 may be referred to as a “ping table” 204 and the data structure 206 may be referred to as a “pong table” 206. The storage 202 also comprises a detection software 201 which, when executed by the processing logic 200, causes the processing logic 200 to perform at least some of the various techniques disclosed herein. In some embodiments, at least some of the techniques disclosed herein may be performed by hardware logic. In some embodiments, at least some of the techniques disclosed herein may be performed using a combination of the software 201 and hardware logic. The storage 202 comprises a computer-readable medium such as any suitable type or types of volatile memory (e.g., random access memory (RAM)), hard drives, flash memory, etc., or combinations thereof. In preferred embodiments, the storage 202 comprises various types of memory. The various memories of storage 202 may be housed within a single unit or among multiple, discrete units. The processing logic 200 also couples to the sensor 116 via an analog-to-digital converter (A/D) 208 and to the display 104.

FIG. 2b shows an illustrative embodiment of the sensor 116 of FIG. 2a. Specifically, the sensor 116 shown in FIG. 2b comprises an array of pixels 250. Each pixel 250 may be referred to using a coordinate (e.g., (row, column)) indicating the position of the pixel in the array. A pixel array may be associated with different types of light-collecting components, depending on the type of sensor 116 being used. For example, in some embodiments, the sensor 116 may comprise a complementary metal oxide semiconductor (CMOS)-based sensor. In at least some such embodiments, each of the pixels 250 may be associated with one or more transistors (e.g., CMOS transistors). The transistors may detect light and the sensor 116 or the processing logic 200 may translate the detected light into one or more digital values. Similarly, in some embodiments, the sensor 116 may comprise a charge-coupled device (CCD)-based sensor. In at least some such embodiments, each of the pixels 250 may be associated with one or more light-sensitive capacitors. The capacitors may detect light and store the light as charge. The charge then may be read either by the sensor 116 and converted to one or more digital values by the A/D 208. The scope of this disclosure is not limited to CCD and CMOS-based sensors. Regardless of the type of sensor 116 that is used, higher digital values generally represent brighter light, and lower digital values generally represent dimmer light. In other embodiments, higher digital values may represent dimmer light and lower digital values may represent brighter light. The term “pixel” is used to describe any suitable photosensitive element, such as a transistor in the case of a CMOS sensor or a capacitor in the case of a CCD sensor, etc. Stated otherwise, a “pixel” is defined to be an individual, light-collecting element of a sensor that has one or more of such elements.

As mentioned, pixels 250 may become defective for various reasons. For example, some pixels 250 may become “dead pixels” which do not detect light or build up a charge and usually result in digital values of zero. Digital images captured using dead pixels often contain dark spots at locations which correspond to the dead pixels. Likewise, some pixels 250 may become “hot pixels.” Hot pixels add a constant offset to signals correspond to light information provided to the pixel to produce the digital value. If this offset exceeds a maximum digital value, the pixel cannot be used to measure the light intensity. Digital images captured using hot pixels often contain bright spots at locations which correspond to the hot pixels. Other such pixel defects also are possible.

Various embodiments of the technique disclosed herein may be used to accurately identify defective pixels and to adjust digital images to compensate for the defective pixels. The technique disclosed herein is advantageous because the technique disclosed herein accurately identifies faulty and hot pixels. Stated otherwise, the disclosed technique reduces, minimizes or eliminates error in which properly-operating pixels are misclassified as defective and defective pixels are misclassified as properly-operating.

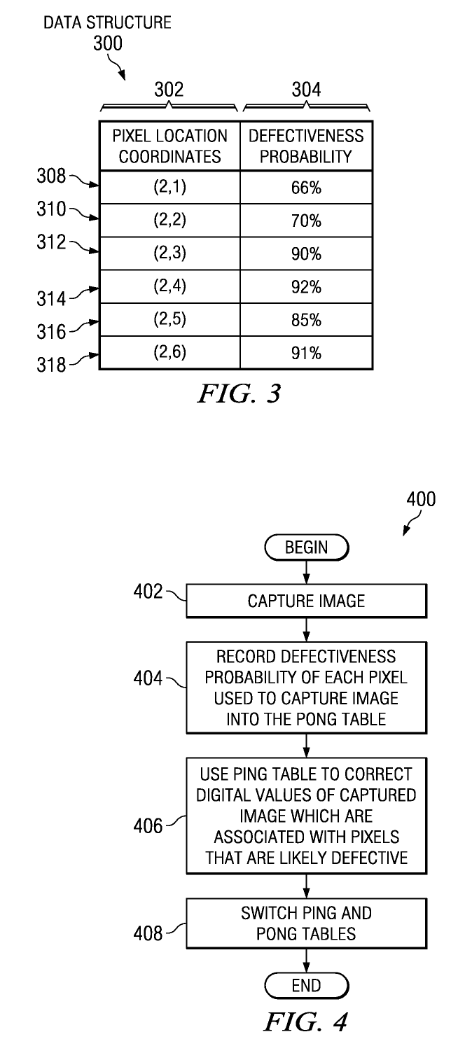

The technique disclosed herein achieves this superior accuracy by repeatedly attempting to identify defective pixels over a period of time and using a plurality of images. The concept behind this technique is that if a pixel is repeatedly identified as a defective pixel, it is more likely to truly be defective than if the pixel was identified as defective just once. For example, if a defective pixel is identified as “normal” (i.e., not defective) based on a single captured image and is identified as defective based on 15 subsequent images, the technique disclosed herein would correctly identify the pixel as defective. Collecting such information over time and using multiple images reduces the probability that a defective pixel will be identified as a “normal” pixel or that a normal pixel will be identified as a defective pixel. Collection of this information is now described in the context of FIGS. 2a, 2b and 3.

In operation, the sensor 116 captures an image using pixels 250. As explained, the image is captured by storing a charge in each of the pixels 250. The charge in each pixel 250 is then converted to a digital value (e.g., multiple bits) either by the sensor 116, if the sensor has such a capability, or by the A/D 208. The processing logic 200 then compares the digital value from each pixel 250 to digital values associated with one or more pixels which neighbor (i.e., are adjacent to and/or in the vicinity of) the pixel 250. The logic 200 determines whether the digital value of the pixel 250 differs from the digital values (e.g., an average of the digital values) of its neighboring pixels by at least a predetermined threshold (e.g., programmed into the storage 202 by a user). These threshold values are used to determine whether a pixel 250 is defective. For example, a threshold may be set at 255 (11111111 in binary form). If a digital value captured by a pixel exceeds digital values of one or more neighboring pixels by 255, that pixel may be defective (i.e., a “hot” pixel). Any number of such thresholds may be programmed into the storage 202. Further, in some embodiments, the storage 202 may be programmed with digital value ranges instead of, or in addition to, discrete threshold values. Threshold values may be determined using any suitable information, including exposure time, location of the pixel in the pixel array, temperature, etc. Instead of using a static threshold value, variable thresholds (e.g., determined using any suitable algorithm) may be used. Further, the scope of this disclosure is not limited to any specific technique for determining the presence of defective (e.g., faulty, hot, dead) pixels. Any suitable technique may be used.

If the processing logic 200 compares the digital value associated with a pixel 250 to one or more thresholds and/or ranges and determines that that pixel 250 is defective, the logic 200 records the location of the pixel 250, the probability that that pixel 250 is truly defective, and possibly other suitable information. The processing logic 200 records such information in the illustrative data structure 300 shown in FIG. 3.

The illustrative data structure 300 is representative of the ping and pong tables mentioned above. The data structure 300 comprises a plurality of columns 302 and 304 and a plurality of rows 308, 310, 312, 314, 316 and 318. Column 302 stores information associated with the locations of pixels 250 (e.g., in coordinate format). Column 304 stores the probability that one or more pixels 250 truly is defective (e.g., in percentage format). Each of rows 308, 310, 312, 314, 316 and 318 is associated with a different pixel 250. For efficiency purposes, in at least some embodiments, each data structure 300 stores information concerning only those pixels 250 which are most probably defective. In other embodiments, information pertaining to all pixels 250 in the sensor 116 is included.

For example, assuming an 8-bit data coding format is implemented, the processing logic 200 may receive a digital value 11111110 associated with a pixel 250 located at coordinate (2,1) (i.e., row 2, column 1) of the pixel array of sensor 116. The processing logic 200 compares the digital value 11111110 (which has a decimal-based value of 254) to digital values of surrounding pixels. For instance, the surrounding pixels may have an average digital value of 11111100 (which has a decimal-based value of 252). The logic 200 may determine that the difference between the digital value 11111110 of the pixel 250 and the average (i.e., 11111100) of the digital values of the surrounding pixels is 00000010 (which has a decimal-based value of 2). If the threshold value is 00000001 (decimal-value of 1), then the digital value associated with pixel 250 is determined to be “too different” from the digital values of its neighboring pixels and, as such, is determined to be defective. Thus, the logic 200 records the coordinate of the pixel in column 302 of row 308 as (2,1). The logic 200 further records the probability that the pixel at (2,1) is truly defective. This probability may be determined using any suitable technique or algorithm as desired by a programmer or end-user. Although an 8-bit coding format is used in the example, the scope of this disclosure includes any suitable coding format (e.g., 10-bit, 12-bit, 14-bit).

In at least some embodiments, the probability is determined based on images captured using the sensor 116 within a predetermined time period. For instance, if, within the course of a single second, the sensor 116 is used to capture two images, the logic 200 will receive two digital values associated with the pixel at location (2,1). If the first digital value falls below the defective pixel threshold, and the second digital value exceeds the defective pixel threshold, the logic 200 may record the probability that the pixel at location (2,1) is defective as 50%. If a third image is captured and the third digital value associated with the pixel at (2,1) also exceeds the threshold, the logic 200 may record the probability of defectiveness as 66% (i.e., two out of three digital values exceed the threshold), and so on. By repeatedly adjusting the probability information over a period of time and using multiple images, the probability information is refined and becomes increasingly accurate. In the current example, if the pixel at (2,1) truly is defective, the probability value in column 304 of row 308 will continue to converge toward 100% with each successive image that is processed by the logic 200.

Other techniques also may be used for determining the defectiveness probability of a pixel. For example, in some embodiments, a pixel may begin with a 50% probability of defectiveness. Each time the pixel is identified as being potentially defective, the defectiveness probability associated with that pixel may be incremented by some predetermined value, such as 5%. Similarly, each time the pixel is not identified as being potentially defective, the defectiveness probability associated with that pixel may be decremented by some predetermined value, such as 3%. In some cases (e.g., if the pixel and its surrounding pixels are pure white), the defectiveness probability associated with the pixel is not adjusted. If the defectiveness probability associated with the pixel reaches some predetermined minimum value, such as 0% (meaning that there is no (or almost no) chance that the pixel is defective), information regarding the pixel is removed from the data structure 300 using any suitable mechanism. Similarly, if the defectiveness probability associated with the pixel reaches some predetermined maximum value, such as 50% (meaning that it is likely that the pixel is defective), the pixel is adjusted as disclosed herein. Values by which defectiveness probabilities are incremented or decremented depend upon various factors (e.g., sensor characteristics and settings, environmental conditions, user preferences).

As mentioned, the data structure 300 is representative of both the ping and pong tables 204 and 206. Both of the ping and pong tables 204 and 206 store statistical data as described in context of FIG. 3. One difference between the tables 204 and 206 is that the ping table 204 is “read” by the logic 200, whereas the pong table 206 is “written” to by the logic 200. More specifically, the ping table 204 usually contains the most current pixel-status information and is thus used by the processing logic 200 to adjust a newly-captured image. For example, if the logic 200 receives digital values of an image recently captured by the sensor 116, the logic 200 uses the ping table 204 to determine which pixels 250 are most likely defective and adjusts the areas of the image that were captured by those defective pixels. For instance, assume that the pixel 250 at location (2,1) has a 66% probability of defectiveness. Thus, it is likely that any light information detected by pixel 250 will be incorrect (i.e., improperly high or low). Because the logic 200 already “knows” that the pixel 250 at (2,1) is defective, when the logic 200 receives a new image from sensor 116, the logic 200 automatically corrects the digital value associated with the pixel 250 at (2,1).

Although the logic 200 uses the ping table 204 to adjust captured images, it is also desirable to regularly update the information in the ping table 204 so that the information is up-to-date and not stagnant or outdated (e.g., to account for pixels that have just recently become defective). Accordingly, before the logic 200 uses ping table 204 to adjust a recently captured image, the logic 200 determines which digital values associated with the image exceed the predetermined threshold(s), range(s), etc. The logic 200 records this information in pong table 206 as described above. After the pong table 206 has been updated, the logic 200 adjusts the image using the ping table 206. The logic 200 then may provide the corrected image to the display 104 for display and/or to storage 202 for storage.

Because the pong table 206 is updated with information from the most recently-processed image and the ping table 204 is not, it is desirable to update the information in the ping table 204 with the information in the pong table 206. Such an update may be accomplished using various techniques. For example, the contents of the entire pong table 206 may be copied to the ping table 204. Alternatively, the ping and pong tables may “trade places” after each image is processed so that the pong table becomes the ping table, and the ping table becomes the pong table. Specifically, in this embodiment, ping and pong table pointers may be swapped. In yet other embodiments, specific portions of the pong table 206 may be copied to the ping table 204 (i.e., only those portions which were updated or newly added by the logic 200). Any and all such techniques are encompassed within the scope of this disclosure. Although two smaller ping and pong tables are used instead of a large, single table in order to positively affect computational efficiency of the logic 200, the scope of this disclosure is not limited to using any specific number or size of tables. Various modifications to the ping and pong table technique are contemplated and included within the scope of this disclosure. Further, various types and quantities of tables may be used (e.g., one or more tables for video, one or more tables for still images, one or more tables for “night-mode”).

As explained above, the logic 200 may use the ping table 204 to determine whether to correct a digital value associated with a pixel 250. In preferred embodiments, such a determination is performed by comparing the defectiveness probability of each pixel (stored in ping table 204) to a predetermined threshold value (e.g., programmed into the storage 202 by a user). The predetermined threshold value may be static or may be adjusted by the logic 200 based on various factors. For example, a predetermined threshold value of 75% indicates that if a pixel 250 has an estimated defectiveness probability of 75% or more (as indicated in ping table 204), then for each image captured, the logic 200 should correct the digital value associated with that pixel. In another example and referring to FIGS. 2a and 3, assume the predetermined threshold value is 50%. The processing logic 200 receives an image from the sensor 116. The processing logic 200 uses the ping table 204 to determine that the pixel 250 at location (2,1) has a defectiveness probability of 66%. Thus, because the probability of 66% exceeds the threshold of 50%, the logic 200 adjusts the digital value associated with the pixel at (2,1). In preferred embodiments, the logic 200 repeats this technique for most or all pixels in the captured image. In some embodiments, the predetermined threshold value may change based on memory footprint criteria. Specifically, as increasing numbers of defective pixels are detected, the storage 202 will eventually reach capacity. In such cases, the logic 200 is adapted to re-determine the predetermined threshold value such that fewer numbers of pixels are classified as “defective.” The technique(s) by which digital value adjustments are performed are now described.

Although any suitable technique may be used to adjust a digital value which is associated with a defective pixel 250, preferred embodiments include correcting the digital value to one that is interpolated using digital values of pixels that surround the defective pixel. A suitable technique includes “subtracting by offset.” Specifically, as previously described, a pixel is compared to its neighbors when determining whether that pixel is defective. In general, the difference in intensity between a pixel and its neighbors is a small value. The average (over time) of this intensity difference is expected to be approximately 0. If the difference is not approximately 0, it is likely that the value returned by the pixel is the expected value plus some offset. This offset is likely to be the average previously mentioned. Accordingly, it is possible to subtract the offset from the pixel digital value to recover the intensity data. In some embodiments, bi-linear or bi-cubic interpolation may be used. The scope of this disclosure is not limited to these techniques. Any suitable interpolation technique may be used. Further, in some embodiments, the logic 200 may use different techniques to correct different digital values associated with a single image. By adjusting the digital value(s) associated with defective pixel(s) 250, the logic 200 produces an image with minimal or no blemishes caused by defective pixels. The blemish-treated image produced by the logic 200 may then be displayed on display 104, compressed and stored to storage 202 and/or transmitted to another communication device via antenna 110.

FIG. 4 shows an illustrative flow diagram of a method 400 implemented in accordance with various embodiments. The method 400 begins by capturing an image (block 402). The method 400 continues by recording into the pong table the defectiveness probability of each pixel used to capture the image (block 404). As previously described, this probability may be determined using any suitable algorithm, including the algorithm described above. The method 400 then comprises using the ping table to correct digital values of the captured image which are associated with pixels that are likely defective (block 406). The method 400 continues by switching the ping and pong tables (e.g., by swapping pointers associated with the tables) (block 408). As the method 400 is repeated multiple times with various images, the defectiveness probabilities stored in the ping and pong tables become increasingly accurate. In this way, the logic 200 can properly compensate for defective pixels. The steps of method 400 may be performed in any suitable manner. For example, in systems implementing dedicated hardware, the steps disclosed in blocks 402 and 404 may occur substantially in parallel. Further, the method 400 may begin with empty ping and/or pong tables, or the ping and/or pong tables may already contain data.

Although the various embodiments are described above as implemented within a single device 100, in some embodiments, the techniques disclosed herein may be implemented in separate devices. For example, referring to FIG. 2a, in some embodiments, images may be captured by device 100 using sensor 116. The images may be transferred to another electronic device (e.g., a personal computer) via the RF circuitry 108 and the antenna 110. The images may be analyzed and corrected as described above in the context of processing logic 200 and the contents of storage 202. The corrected images and/or other pertinent information may then be transmitted to the device 100 and used by the device 100 as desired.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a sensor having a photosensitive element and adapted to capture images; and
processing logic adapted to determine the probability that the photosensitive element is defective based on digital values from multiple images, said digital values associated with the photosensitive element;
wherein, if said probability exceeds a threshold, the processing logic adjusts a digital value of another image captured using the photosensitive element.

2. The system of claim 1, wherein the system comprises a mobile communication device.

3. The system of claim 1, wherein the system comprises a data structure that cross-references each of a plurality of photosensitive elements with a different probability value that indicates the probability that the associated photosensitive element is defective.

4. The system of claim 3, wherein the system comprises a second data structure that cross-references each of said plurality of photosensitive elements with a modified probability value that indicates the probability that the associated photosensitive element is defective, the modified probability values more current than said different probability values.

5. The system of claim 1, wherein the sensor comprises a plurality of photosensitive elements, and wherein the processing logic is adapted to determine a defectiveness probability associated with each of said plurality of photosensitive elements in the same manner by which the processing logic determines said probability for said photosensitive element.

6. The system of claim 1, wherein the photosensitive element comprises a component selected from the group consisting of a capacitor and a transistor.

7. The system of claim 1, wherein the processing logic is adapted to adjust said digital value of said another image using a technique selected from the group consisting of offset subtraction and interpolation using digital values of photosensitive elements adjacent to said photosensitive element.

8. The system of claim 1, wherein the processing logic is adapted to determine the probability by comparing the digital values of said multiple images with other digital values associated with other photosensitive elements neighboring said photosensitive element to produce a difference, and by comparing said difference with a second threshold value.

9. The system of claim 1, wherein the system is adapted to display said another image, store said image, transmit said image to a different device, encode said image and encode said image in conjunction with a series of other images.

10. A system, comprising:
processing logic;
a sensor comprising a photosensitive pixel adapted to store a charge;
converter logic adapted to convert said charge to a digital value; and
storage comprising a data structure, the data structure cross-references the photosensitive pixel with a probability value that said photosensitive pixel is defective;
wherein, for each of a plurality of images captured by the sensor, the processing logic uses a digital value associated with the photosensitive pixel to adjust said probability value;
wherein, if the probability value exceeds a threshold, the processing logic adjusts a digital value of another image, said another image captured by the photosensitive pixel.

11. The system of claim 10, wherein the system comprises a mobile communication device.

12. The system of claim 10, wherein the system comprises a second data structure that cross-references the photosensitive pixel with another probability value that said photosensitive pixel is defective, said another probability value is more current than the probability value.

13. The system of claim 10, wherein the photosensitive element comprises a component selected from the group consisting of a capacitor and a transistor.

14. The system of claim 10, wherein the processing logic adjusts the digital value of said another image using offset subtraction or interpolation.

15. The system of claim 10, wherein said threshold is variable.

16. The system of claim 10, wherein, if the probability value drops below a second threshold, an entry associated with the probability value is removed from the data structure.

17. A method, comprising:
capturing multiple images using a photosensitive element, said images associated with multiple digital values;
determining differences between said multiple digital values;
based on said differences, adjusting a probability value which indicates the probability that the photosensitive element is defective; and
if said probability exceeds a threshold, adjusting a different digital value of a different image, said different digital value associated with the photosensitive element.

18. The method of claim 17 further comprising performing an action selected from the group consisting of transferring said different image to a different device, storing said different image, or displaying said different image.

19. The method of claim 17 further comprising storing said probability value in a data structure, the data structure cross-references the probability value with a coordinate associated with the photosensitive element.

20. The method of claim 17 further comprising:
storing coordinates for a plurality of photosensitive elements in a first data structure and in a second data structure, each of the data structures cross-references said coordinates with probabilities that some of the plurality of photosensitive elements are defective, the second data structure more recently updated than the first data structure; and
transferring a predetermined portion of the contents of the second data structure to the first data structure.

21. The method of claim 17 further comprising:
storing coordinates for a plurality of photosensitive elements in a first data structure and in a second data structure, each of the data structures cross-references said coordinates with probabilities that some of the plurality of photosensitive elements are defective, the second data structure more recently updated than the first data structure; and
re-classifying the first data structure as the second data structure and the second data structure as the first data structure.

22. The method of claim 17 further comprising:
storing coordinates for a plurality of photosensitive elements in a first data structure and in a second data structure, each of the data structures cross-references said coordinates with probabilities that some of the plurality of photosensitive elements are defective, the second data structure more recently updated than the first data structure;
wherein one of said first and second data structures is generated or updated while adjusting said different digital value of said different image.

23. The method of claim 17 further comprising modifying said threshold based on a size of a storage associated with the photosensitive element.
